(19) United States
(12) Patent Application Publication
(10) Pub. No.: US 2023/0265363 A1
(43) Pub. Date: Aug. 24, 2023

(54) Container comprising a plurality of pastilles and pastille comprising a major solid phase and a minor solid phase

(71) Applicants: J. Drew HARRISON, Suwanee, GA (US); Value Smart Products Inc., Suwanee, GA (US)

(72) Inventor: J. Drew Harrison, Suwanee, GA (US)

(73) Assignee: Value Smart Products Inc., Suwanee, GA (US)

(21) Appl. No.: 18/043,597

(22) PCT Filed: Aug. 31, 2021
(86) PCT No.: PCT/US21/48330

§ 371 Date: Mar. 1, 2023

Related U.S. Application Data
(60) Provisional application No. 63/073,160, filed on Sep. 1, 2020.

(51) Int. Cl. C11D 11/00; C11D 17/06; C11D 3/50

(52) U.S. Cl. CPC C11D 11/0017; C11D 17/06; C11D 3/502

(57) ABSTRACT

Described herein is a container comprising a total plurality of laundry pastilles. The total plurality of laundry pastilles may comprise a first plurality of laundry pastilles and a second plurality of laundry pastilles with the first plurality of laundry pastilles comprising a laundry scent booster composition and the second plurality of laundry pastilles comprising a composition which increases a performance characteristic of the total plurality of laundry pastilles. Also described herein is a laundry pastille comprising a major solid phase and a first minor solid phase.

### CROSS REFERENCES AND PRIORITIES

This application claims priority from U.S. Provisional Application No. 63/073,160 filed on 1 Sep. 2020 the teachings of which are incorporated by reference herein in their entirety.

### BACKGROUND

Laundry scent boosters have become increasingly important within the laundry care category. In essence, these products provide additional fragrance, preferably including fragrance released after extended periods, in addition to that provided by classic laundry products such as detergents, stain removers, and fabric softeners. It is especially preferred that these products are delivered into the washing cycle, and that they provide significant fragrance impact post-washing, while being stored before wearing, and during subsequent wear.

While laundry scent boosters provide additional fragrance, traditional laundry scent boosters offer little to no benefit in terms of traditional laundry performance such as cleaning, stain removal, deoderizing, and sanitizing. The need exists, therefore for an improved laundry scent booster.

### SUMMARY

Disclosed herein is a container comprising a total plurality of laundry pastilles. The total plurality of laundry pastilles may comprise at least a first plurality of laundry pastilles of the total plurality of laundry pastilles and a second plurality of laundry pastilles of the total plurality of laundry pastilles.

Each laundry pastille of the first plurality of laundry pastilles may comprise a laundry scent booster composition. Each laundry pastille of the second plurality of laundry pastilles may comprise a composition which increases a performance characteristic of the total plurality of laundry pastilles.

The first plurality of laundry pastilles may comprise between 50% by weight and 99% by weight of the total plurality of laundry pastilles. The second plurality of laundry pastilles may comprise between 1% by weight and 50% by weight of the total plurality of laundry pastilles. The weight percent of the first plurality of laundry pastilles and the second plurality of laundry pastilles may combine to total 100% by weight of the total plurality of laundry pastilles.

In some embodiments, the laundry scent booster composition may comprise a carrier and a fragrance. The carrier may be present in the laundry scent booster composition in a first amount which may be in the range of between 90% by weight and 99% by weight of the laundry scent booster composition. The fragrance may be present in the laundry scent booster composition in a second amount which may be in the range of between 2% by weight and 10% by weight of the laundry scent booster composition. The weight percent of all the components of the laundry scent booster composition may combine to total 100% by weight of the laundry scent booster composition.

In certain embodiments of the laundry scent booster composition, the carrier may comprise at least one component selected from the group consisting of polyethylene glycol, sodium acetate, polyethylene glycol monostearyl ether, the polyethylene glycol stearates, and the poloxamers. In some such embodiments, the carrier may comprise polyethylene glycol having a number-averaged molecular weight from about 2000 to about 4000.

In some embodiments of the laundry scent booster composition, the carrier may comprise a hydrated salt. The hydrated salt may be selected from the group consisting of sodium acetate trihydrate, magnesium nitrate hexahydrate, magnesium chloride hexahydrate, and magnesium sulfate heptahydrate. In certain such embodiments, the hydrated salt may have a melting point of less than 150° C.

In certain embodiments of the laundry scent booster composition, the fragrance may comprise a fragrance oil. In some such embodiments, the fragrance oil may be present in the laundry scent booster composition in a third amount in the range of between 1% by weight and 10% by weight of the laundry scent booster composition.

In some embodiments of the laundry scent booster composition, the fragrance may comprise a perfume microencapsulate or microcapsule. In certain such embodiments, the perfume microencapsulate or microcapsule may be present in the laundry scent booster composition in a fourth amount in the range of between 1% by weight and 10% by weight of the laundry scent booster composition.

In certain embodiments, the composition which increases a performance characteristic of the total plurality of laundry pastilles may comprise a fragrancing composition. The fragrancing composition may be selected from the group consisting of at least one odor eliminator, at least one fragrance oil, and at least one micro-encapsulated fragrance in solid form.

In some embodiments, the composition which increases a performance characteristic of the total plurality of laundry pastilles may comprise a cleaning composition. The cleaning composition may be selected from the group consisting of at least one enzyme and at least one surfactant.

In certain embodiments, the composition which increases a performance characteristic of the total plurality of laundry pastilles may comprise at least one disinfecting composition. In other embodiments, the composition which increases a performance characteristic of the total plurality of laundry pastilles may comprise at least one optical brightener.

In some embodiments, the first plurality of laundry pastilles may have a different color than the second plurality of laundry pastilles.

In certain embodiments, the total plurality of laundry pastilles may comprise at least one subsequent plurality of laundry pastilles. When present, each subsequent plurality of laundry pastilles may comprise a composition which is either the laundry scent booster composition or the composition which increases a performance characteristic of the total plurality of laundry pastilles. In some embodiments, each subsequent plurality of laundry pastilles may have a different color.

In some embodiments, the total plurality of laundry pastilles may be used as a laundry fabric softener.

It is also disclosed herein a laundry pastille comprising a major solid phase and at least one minor solid phase.

In some embodiments, the major solid phase may comprise a carrier and a fragrance. In certain such embodiments, the carrier may be present in the major solid phase in a first amount in the range of between 90% by weight and 99% by weight of the major solid phase. In some such embodiments, the fragrance may be present in the major solid phase in a second amount in the range of between 2% by weight and 10% by weight of the major solid phase. In certain such embodiments, the weight percent of all the components of the major solid phase may combine to total 100% by weight of the major solid phase.

In certain embodiments of the major solid phase, the carrier may comprise at least one component selected from the group consisting of polyethylene glycol, sodium acetate, polyethylene glycol monostearyl ether, the polyethylene glycol stearates, and the poloxamers. In some such embodiments, the carrier may comprise polyethylene glycol having a number-averaged molecular weight from about 2000 to about 4000.

In some embodiments of the major solid phase, the carrier may comprise a hydrated salt. The hydrated salt may be selected from the group consisting of sodium acetate trihydrate, magnesium nitrate hexahydrate, magnesium chloride hexahydrate, and magnesium sulfate heptahydrate. In certain such embodiments, the hydrated salt may have a melting point of less than 150° C.

In certain embodiments of the major solid phase, the fragrance may comprise a fragrance oil. In some such embodiments, the fragrance oil may be present in the major solid phase in a third amount in the range of between 1% by weight and 10% by weight of the major solid phase.

In some embodiments of the major solid phase, the fragrance may comprise a perfume microencapsulate or microcapsule. In certain such embodiments, the perfume microencapsulate or microcapsule may be present in the major solid phase in a fourth amount in the range of between 1% by weight and 10% by weight of the major solid phase.

In certain embodiments, the minor solid phase may comprise a fragrancing composition. The fragrancing composition may be selected from the group consisting of at least one odor eliminator, at least one fragrance oil, and at least one micro-encapsulated fragrance in solid form.

In some embodiments, the minor solid phase may comprise a cleaning composition. The cleaning composition may be selected from the group consisting of at least one enzyme and at least one surfactant.

In certain embodiments, the minor solid phase may comprise at least one disinfecting composition. In other embodiments, the minor solid phase may comprise at least one optical brightener.

In some embodiments, the at least one minor solid phase is present in the major solid phase as a plurality of specks distributed in the major solid phase. In other embodiments, the at least one minor solid phase may be present in the major solid phase as a dot in the major solid phase. In still other embodiments, the at least one minor solid phase may be present in the major solid phase as a stripe in the major solid phase. In yet other embodiments, the at least one minor solid phase may be present in the major solid phase as a swirl in the major solid phase.

In certain embodiments, the major solid phase and the minor solid phase may each have a different color.

In some embodiments, the laundry pastille may be used as a laundry fabric softener.

### BRIEF DESCRIPTION OF FIGURES

FIG. 1 depicts a perspective view of one embodiment of a plurality of laundry pastilles in a container.

FIG. 2 depicts a perspective view of one embodiment of a laundry pastille.

FIG. 3 depicts a side view of the embodiment of a laundry pastille of FIG. 2.

FIG. 4 depicts a top view of the embodiment of a laundry pastille of FIG. 2.

FIG. 5 depicts a bottom view of the embodiment of a laundry pastille of FIG. 2.

FIG. 6 depicts a front view of the embodiment of a laundry pastille of FIG. 2.

FIG. 7 depicts a rear view of the embodiment of a laundry pastille of FIG. 2.

FIG. 8 depicts a perspective view of one embodiment of a laundry pastille.

FIG. 9 depicts a side view of the embodiment of a laundry pastille of FIG. 8.

FIG. 10 depicts a top view of the embodiment of a laundry pastille of FIG. 8.

FIG. 11 depicts a bottom view of the embodiment of a laundry pastille of FIG. 8.

FIG. 12 depicts a front view of the embodiment of a laundry pastille of FIG. 8.

FIG. 13 depicts a rear view of the embodiment of a laundry pastille of FIG. 8.

FIG. 14 depicts a perspective view of one embodiment of a laundry pastille.

FIG. 15 depicts a side view of the embodiment of a laundry pastille of FIG. 14.

FIG. 16 depicts a top view of the embodiment of a laundry pastille of FIG. 14.

FIG. 17 depicts a bottom view of the embodiment of a laundry pastille of FIG. 14.

FIG. 18 depicts a front view of the embodiment of a laundry pastille of FIG. 14.

FIG. 19 depicts a rear view of the embodiment of a laundry pastille of FIG. 14.

FIG. 20 depicts a perspective view of one embodiment of a laundry pastille.

FIG. 21 depicts a side view of the embodiment of a laundry pastille of FIG. 20.

FIG. 22 depicts a top view of the embodiment of a laundry pastille of FIG. 20.

FIG. 23 depicts a bottom view of the embodiment of a laundry pastille of FIG. 20.

FIG. 24 depicts a front view of the embodiment of a laundry pastille of FIG. 20.

FIG. 25 depicts a rear view of the embodiment of a laundry pastille of FIG. 20.

### DETAILED DESCRIPTION

Disclosed herein is a container comprising a plurality of laundry pastilles. Also disclosed herein is a laundry pastille. The laundry pastille and container comprising a plurality of laundry pastilles are described below with reference to the Figures. As described herein and in the claims, the following numbers refer to the following structures as noted in the Figures.
10 refers to a container.
20 refers to a first plurality of laundry pastilles.
30 refers to a second plurality of laundry pastilles.
100 refers to a laundry pastille.
110 refers to a major solid phase.
120 refers to a first minor solid phase.

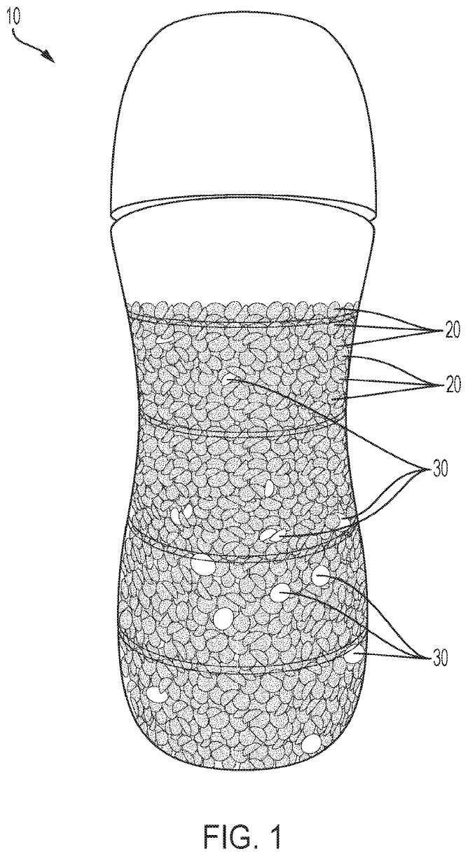

One embodiment of the invention—shown in FIG. 1—is a container (10) comprising a total plurality of laundry pastilles. The total plurality of laundry pastilles may be divided into a first plurality of laundry pastilles (20) of the total plurality of laundry pastilles, and a second plurality of laundry pastilles (30) of the total plurality of laundry pastilles.

Each individual laundry pastille of the first plurality of laundry pastilles (20) may comprise a laundry scent booster composition. Conversely, each individual laundry pastille of the second plurality of laundry pastilles (30) may comprise a composition which increases a performance characteristic of the total plurality of laundry pastilles.

Within the container (10), the amount of the first plurality of laundry pastilles (20) may be at or above 50% by weight of the total plurality of laundry pastilles, at or above 75% by weight of the total plurality of laundry pastilles, or in the range of between 50% by weight and 99% by weight of the total plurality of laundry pastilles, or in the range of between 50% by weight and 90% by weight of the total plurality of laundry pastilles, or in the range of between 50% by weight and 75% by weight of the total plurality of laundry pastilles, or in the range of between 60% by weight and 99% by weight of the total plurality of laundry pastilles, or in the range of between 60% by weight and 90% by weight of the total plurality of laundry pastilles, or in the range of between 60% by weight and 75% by weight of the total plurality of laundry pastilles.

Within the container (10), the amount of the second plurality of laundry pastilles (30) may be at or above 1% by weight of the total plurality of laundry pastilles, at or above 5% by weight of the total plurality of laundry pastilles, or in the range of between 1% by weight and 50% by weight of the total plurality of laundry pastilles, or in the range of between 10% by weight and 50% by weight of the total plurality of laundry pastilles, or in the range of between 25% by weight and 50% by weight of the total plurality of laundry pastilles, or in the range of between 1% by weight and 40% by weight of the total plurality of laundry pastilles, or in the range of between 10% by weight and 40% by weight of the total plurality of laundry pastilles, or in the range of between 25% by weight and 40% by weight of the total plurality of laundry pastilles.

In certain embodiments, not shown, there may be at least one subsequent plurality of laundry pastilles. Each subsequent plurality of laundry pastilles may have a composition which is either a laundry scent booster composition as described herein with reference to the first plurality of laundry pastilles (20) or a composition which increases a performance characteristic of the total plurality of laundry pastilles as described herein with reference to the second plurality of laundry pastilles (30).

The number of subsequent pluralities of laundry pastilles may be selected from the group consisting of one subsequent plurality of laundry pastilles (also referred to herein as a first subsequent plurality of laundry pastilles), two subsequent pluralities of laundry pastilles (also referred to herein as a first and a second subsequent plurality of laundry pastilles), three subsequent pluralities of laundry pastilles (also referred to herein as a first, second, and third subsequent plurality of laundry pastilles), four subsequent pluralities of laundry pastilles (also referred to herein as a first, second, third, and fourth subsequent plurality of laundry pastilles), five subsequent pluralities of laundry pastilles (also referred to herein as a first, second, third, fourth, and fifth subsequent plurality of laundry pastilles), six subsequent pluralities of laundry pastilles (also referred to herein as a first, second, third, fourth, fifth, and sixth subsequent plurality of laundry pastilles), and seven subsequent pluralities of laundry pastilles (also referred to herein as a first, second, third, fourth, fifth, sixth, and seventh subsequent plurality of laundry pastilles. Certain embodiments may exist having more that seven subsequent pluralities of laundry pastilles. In some embodiments, each of the first plurality of laundry pastilles, the second plurality of laundry pastilles, and each subsequent plurality of laundry pastilles may have a different color.

In all such embodiments, the weight percent of the first plurality of laundry pastilles, the second plurality of laundry pastilles, and the (optional) subsequent pluralities of laundry pastilles may combine to total 100% by weight of the total plurality of laundry pastilles.

In the first plurality of laundry pastilles, the laundry scent booster composition may comprise an amount of polyethylene glycol (“PEG”) also known as polyethylene oxide, an amount of a hydrated salt, and an amount of a fragrance.

Polyethylene glycol may be safe for human consumption, e.g., substantially non-toxic, e.g., a medically acceptable PEG identified as CAS Reg. No. 25322-68-3. The PEG may be of a number-averaged molecular weight that results in it being solid at room temperature, and more preferably remains solid in conditions that are experienced throughout the process of being distributed to the consumer. The PEG may be of a number-averaged molecular weight at or above 2000, or at or above 3350, or at or above 4000, or from about 2000 to about 4000, or from about 3000 to about 4000, or from about 3000 to about 5000, or from about 4000 to about 5000. The amount of polyethylene glycol may be at or above 50% by weight of the laundry scent booster composition, or at or above 60% by weight of the laundry scent booster composition, or in the range of between 50% by weight and 70% by weight of the laundry scent booster composition, or in the range of between 50% by weight and 65% by weight of the laundry scent booster composition, or in the range of between 50% by weight and 60% by weight of the laundry scent booster composition, or in the range of between 55% by weight and 70% by weight of the laundry scent booster composition, or in the range of between 55% by weight and 65% by weight of the laundry scent booster composition, or in the range of between 60% by weight and 70% by weight of the laundry scent booster composition.

The polyethylene glycol, when used, acts as a carrier for other components of the first plurality of laundry pastilles. Alternative carriers which may be used instead of or in addition to polyethylene glycol include sodium acetate, polyethylene glycol monostearyl ether (sometimes referred to as Steareth), the polyethylene glycol stearates, and the poloxamers (sometimes referred to under the trade names Pluronic, Synperonics, and Kolliphor). In general, the total amount of carrier in the laundry scent booster composition (which is the sum of all of the components comprising the carrier) will be at or above 90% by weight of the laundry scent booster composition, or at or above 95% by weight of the laundry scent booster composition, or in the range of between 90% by weight and 99% by weight of the laundry scent booster composition, or in the range of between 90% by weight and 97.5% by weight of the laundry scent booster composition, or in the range of between 90% by weight and 95% by weight of the laundry scent booster composition, or in the range of between 95% by weight and 99% by weight of the laundry scent booster composition, or in the range of between 95% by weight and 97.5% by weight of the laundry scent booster composition, or in the range of between 97.5% by weight and 99% by weight of the laundry scent booster composition.

The carrier may also comprise the hydrated salts. Examples of hydrated salts include, but are not limited to, sodium acetate trihydrate, magnesium nitrate hexahydrate, magnesium chloride hexahydrate, and magnesium sulfate heptahydrate (also known as Epsom salt). In general, the hydrated salt should have a melting point of less than 150° C., preferably less than 125° C., most preferably less than 100° C. Especially preferred hydrated salts will have a melting point below 60° C. The amount of hydrated salt may be at or above 20% by weight of the laundry scent booster composition, at or above 30% by weight of the laundry scent booster composition, at or above 40% by weight of the laundry scent booster composition, or in the range of between 20% by weight and 40% by weight of the laundry scent booster composition, or in the range of between 20% by weight and 35% by weight of the laundry scent booster composition, or in the range of between 20% by weight and 30% by weight of the laundry scent booster composition, or in the range of between 25% by weight and 40% by weight of the laundry scent booster composition, or in the range of between 25% by weight and 35% by weight of the laundry scent booster composition, or in the range of between 30% by weight and 40% by weight of the laundry scent booster composition.

The fragrance may be at or above 2% by weight of the laundry scent booster composition, at or above 6% by weight of the laundry scent booster composition, at or above 10% by weight of the laundry scent booster composition, or in the range of between 2% by weight and 10% by weight of the laundry scent booster composition, or in the range of between 2% by weight and 8% by weight of the laundry scent booster composition, or in the range of between 2% by weight and 6% by weight of the laundry scent booster composition, or in the range of between 4% by weight and 10% by weight of the laundry scent booster composition, or in the range of between 4% by weight and 8% by weight of the laundry scent booster composition, or in the range of between 6% by weight and 10% by weight of the laundry scent booster composition.

The fragrance may be—or may comprise—a fragrance oil. Fragrance oils are available from multiple sources, such as Berjd, Cateret, N.J.; Firmenich, Geneva, Switzerland; Givaudan, Vernier, Switzerland; International Flavors & Fragrances, New York, N.Y.; and Symrise, Holzminden, Germany. When used, the amount of fragrance oil may be at or above 1% by weight of the laundry scent booster composition, at or above 3% by weight of the laundry scent booster composition, at or above 5% by weight of the laundry scent booster composition, or in the range of between 1% by weight and 10% by weight of the laundry scent booster composition, or in the range of between 1% by weight and 7.5% by weight of the laundry scent booster composition, or in the range of between 1% by weight and 5% by weight of the laundry scent booster composition, or in the range of between 2.5% by weight and 10% by weight of the laundry scent booster composition, or in the range of between 2.5% by weight and 7.5% by weight of the laundry scent booster composition, or in the range of between 5% by weight and 10% by weight of the laundry scent booster composition.

The fragrance may be—or may comprise—a perfume microencapsulate or microcapsule. By the term perfume microencapsulate or microcapsule it is meant those microcapsules described in United States Patent Publication No. 2013/0267454 A1, the teachings of which are incorporated by reference herein in their entirety. When used, the amount of perfume microencapsulate or microcapsule may be at or above 1% by weight of the laundry scent booster composition, at or above 3% by weight of the laundry scent booster composition, at or above 5% by weight of the laundry scent booster composition, or in the range of between 1% by weight and 10% by weight of the laundry scent booster composition, or in the range of between 1% by weight and 7.5% by weight of the laundry scent booster composition, or in the range of between 1% by weight and 5% by weight of the laundry scent booster composition, or in the range of between 2.5% by weight and 10% by weight of the laundry scent booster composition, or in the range of between 2.5% by weight and 7.5% by weight of the laundry scent booster composition, or in the range of between 5% by weight and 10% by weight of the laundry scent booster composition. The perfume microencapsulate or microcapsule may be utilized in addition to or instead of the fragrance oil.

In all embodiments, all the weight percent of all the components of the laundry scent booster composition combine to total 100% by weight of the laundry scent booster composition.

The composition of the second (and optionally subsequent) plurality of laundry pastilles which increases a performance characteristic of the total plurality of laundry pastilles may be present in a carrier. The carrier may comprise an amount of polyethylene glycol and an amount of a hydrated salt. The polyethylene glycol may be of any type and present in any amount disclosed herein with reference to the first plurality of laundry pastilles. Alternatives which may be used in addition to or in place of polyethylene glycol may include sodium acetate, polyethylene glycol monostearyl ether (sometimes referred to as Steareth), the polyethylene glycol stearates, and the poloxamers (sometimes referred to under the trade names Pluronic, Synperonics, and Kolliphor). The hydrated salt may be of any type and present in any amount disclosed herein with reference to the first plurality of laundry pastilles.

One example of a composition which increases a performance characteristic of the total plurality of laundry pastilles is a fragrancing composition. Another example of such a composition is a cleaning composition. Yet another example of such a composition is a disinfecting composition, which may also be referred to as a sanitizing composition. Still another example of such a composition is an optical brightener. The fragrancing composition, cleaning composition, disinfecting composition, and optical brightener may exist alone or in various combinations in the second or (optional) subsequent plurality of laundry pastilles. That is to say, that the second or (optional) subsequent plurality of laundry pastilles may comprise at least one laundry pastille selected from the group consisting of a laundry pastille comprising at least one fragrancing composition, a laundry pastille comprising at least one cleaning composition, a laundry pastille comprising at least one disinfecting composition, a laundry pastille comprising at least one optical brightener, and combinations thereof.

When present, the fragrancing composition may be selected from the group consisting of at least one odor eliminator, at least one fragrance oil, at least one micro-encapsulated fragrance in solid form, and combinations thereof. Non-limiting examples of an odor eliminator include zinc ricinoleate, beta-cyclodextrin, zinc polyitaconate, and combinations thereof. The fragrance oil—when present in the fragrancing composition—may include any of the fragrance oils disclosed herein. The micro-encapsulated fragrance in solid form—when present—may include any of the perfume microencapsulates or microcapsules disclosed herein.

When present, the cleaning composition may be selected from the group consisting of at least one enzyme, at least one surfactant, and combinations thereof. Non-limiting examples of an enzyme include at least one protease enzyme, at least one amylase enzyme, at least one lipase enzyme, at least one cellulase enzyme, at least one mannanase enzyme, and combinations thereof. Non-limiting examples of a surfactant include anionic surfactants, nonionic surfactants, and combinations thereof. Non-limiting examples of anionic surfactants include sodium alkylbenzene sulfonate, sodium olefin sulfonate, sodium alkyl sulfate, and combinations thereof. Non-limiting examples of nonionic surfactants include polyethoxylated alcohols, polypropoxylated alcohols, polyalkoxylated alcohols, polyethoxylated amines, polypropoxylated amines, polyalkoxylated amines, and combinations thereof.

Non-limiting examples of a disinfecting composition (also referred to as a sanitizing composition) include halogen bleaches, quaternary ammonium compounds, phenolics, o-Phenoxyphenol, chlorophenols such as triclosan and 2,4,4′-trichloro-2′-hydroxydiphenyl ether, pine oil, formaldehyde generators, acids such as glycolic acid, sorbic acid, and benzoic acid; sodium hydroxymethyl glycinate, boric acid, and combinations thereof.

Non-limiting examples of an optical brightener include diaminostilbene (DAS) type optical brighteners, Distyrylbiphenyl (DSBP) type optical brighteners, polysulfonated triazolyl type optical brighteners, and combinations thereof.

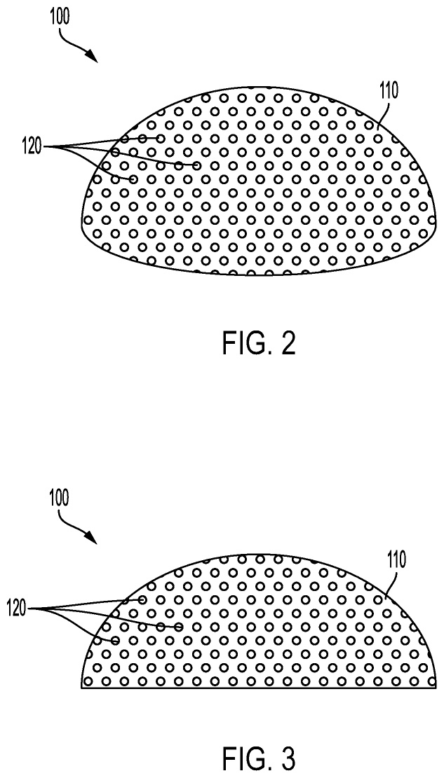

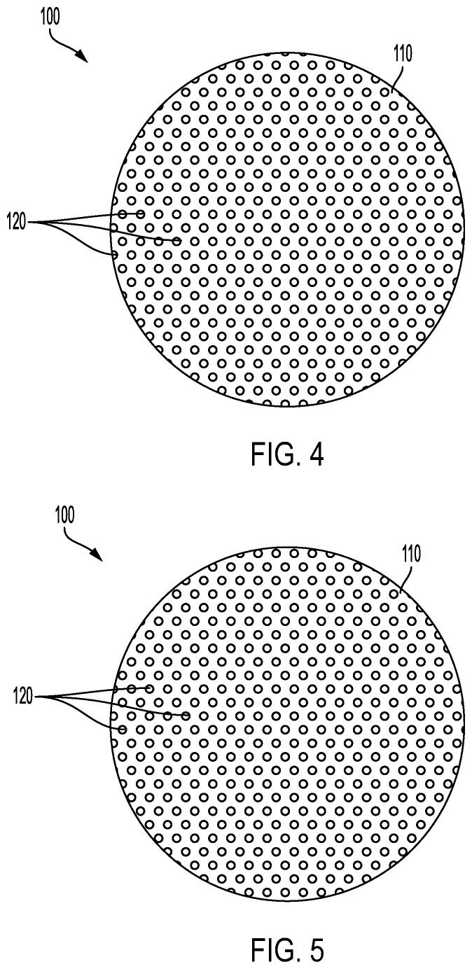

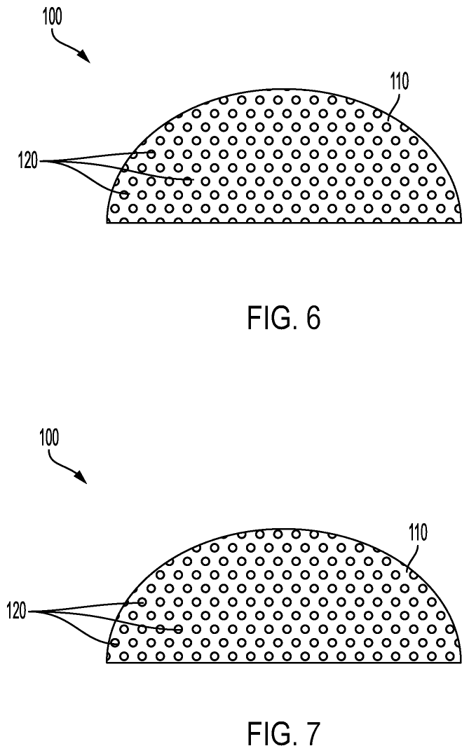

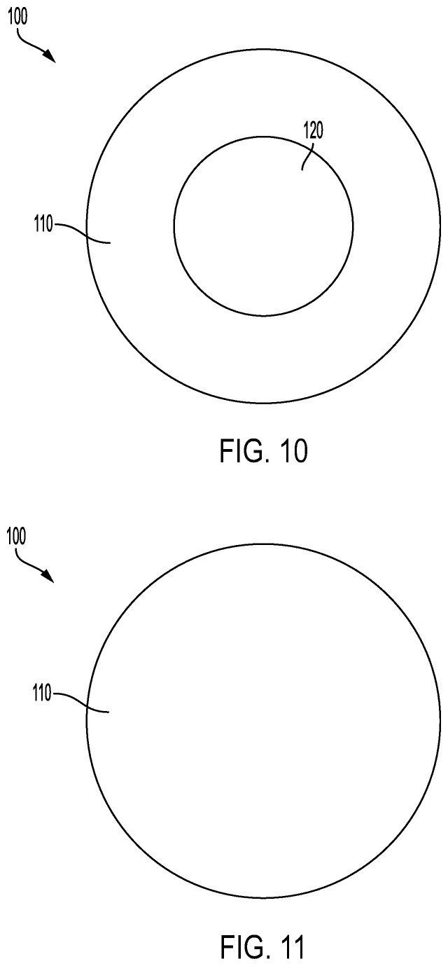

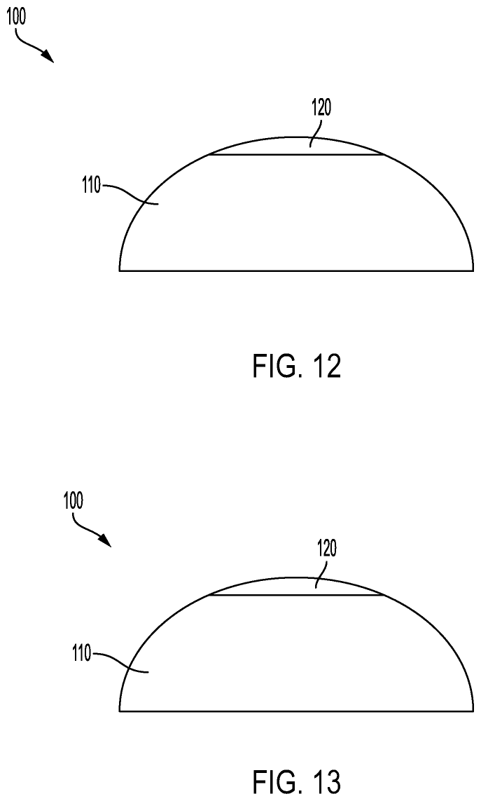

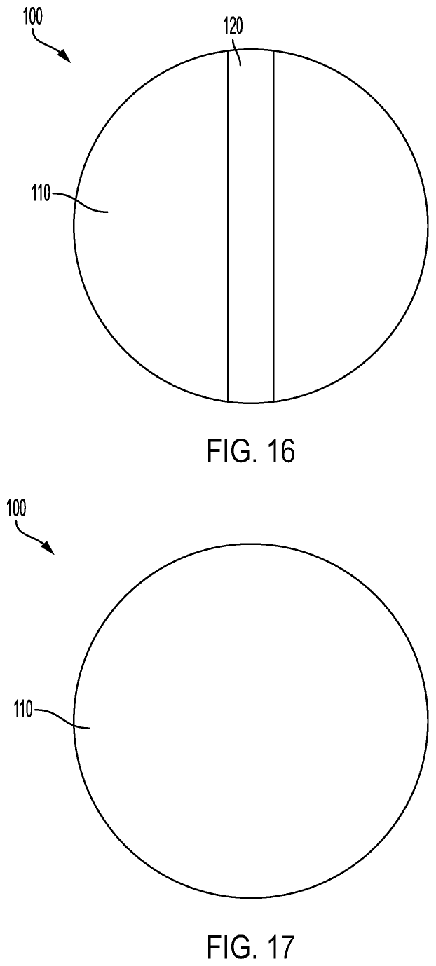

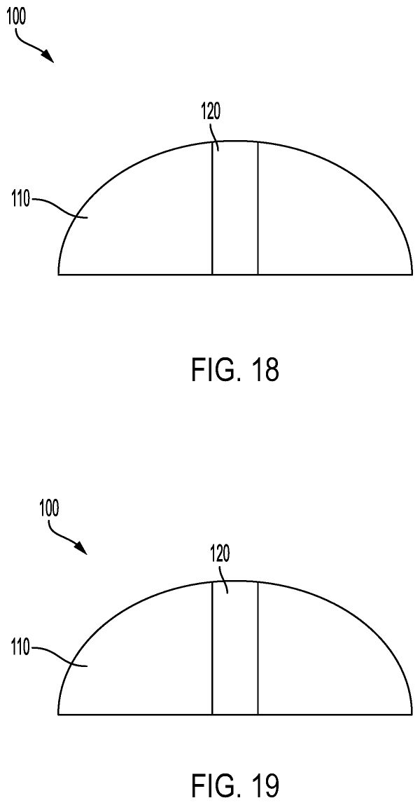

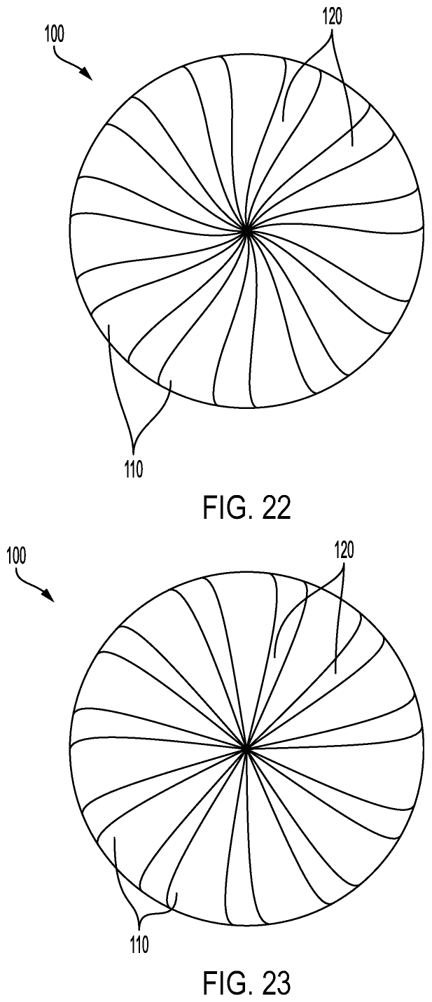

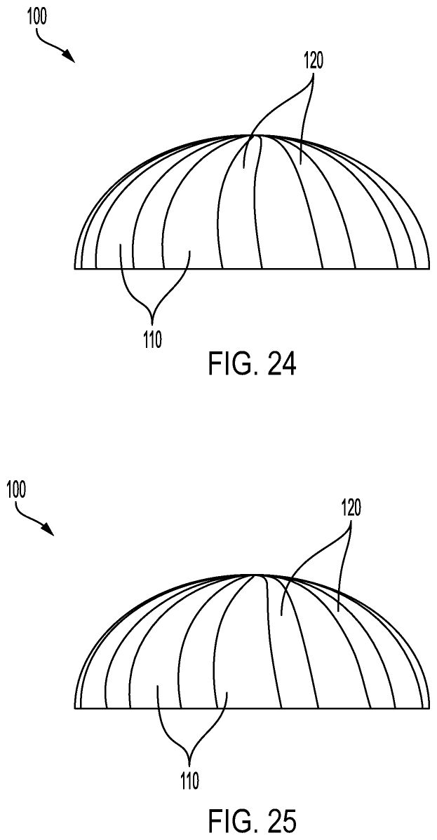

FIGS. 2 through 25 show alternative embodiments wherein one or more individual laundry pastilles is divided into at least two distinct solid phases. The two solid phases may be referred to as a major solid phase and at least one minor solid phase. In embodiments having more than one minor solid phase, the minor solid phases may be referred to as a first minor solid phase, a second minor solid phase, a third minor solid phase, and so on. In some embodiments, the major solid phase and each minor solid phase may have a different color.

The major solid phase generally comprises a laundry scent booster composition while the minor solid phase(s) may comprise a variety of compositions whose presence add or increase certain performance characteristics of the laundry pastille. As shown in the Figures the major solid phase (110) may be present in a first compartmentalized zone of the laundry pastille (100). The minor solid phase(s) (120) may be present in second and (optional) subsequent compartmentalized zones of the laundry pastille. The minor solid phase(s) may be immiscible with the major solid phase such that the minor solid phase(s) are dispersed within the major solid phase.

The major solid phase may comprise a laundry scent booster composition. The laundry scent booster composition may comprise an amount of polyethylene glycol (“PEG”) also known as polyethylene oxide, an amount of a hydrated salt, and an amount of a fragrance.

Polyethylene glycol may be safe for human consumption, e.g., substantially non-toxic, e.g., a medically acceptable PEG identified as CAS Reg. No. 25322-68-3. The PEG may be of a number-averaged molecular weight that results in it being solid at room temperature, and more preferably remains solid in conditions that are experienced throughout the process of being distributed to the consumer. The PEG may be of a number-averaged molecular weight at or above 2000, or at or above 3350, or at or above 4000, or from about 2000 to about 4000, or from about 3000 to about 4000, or from about 3000 to about 5000, or from about 4000 to about 5000. The amount of polyethylene glycol may be at or above 50% by weight of the major solid phase, or at or above 60% by weight of the major solid phase, or in the range of between 50% by weight and 70% by weight of the major solid phase, or in the range of between 50% by weight and 65% by weight of the major solid phase, or in the range of between 50% by weight and 60% by weight of the major solid phase, or in the range of between 55% by weight and 70% by weight of the major solid phase, or in the range of between 55% by weight and 65% by weight of the major solid phase, or in the range of between 60% by weight and 70% by weight of the major solid phase.

The polyethylene glycol, when used, acts as a carrier for other components of the major solid phase. Alternative carriers which may be used instead of or in addition to polyethylene glycol include sodium acetate, polyethylene glycol monostearyl ether (sometimes referred to as Steareth), the polyethylene glycol stearates, and the poloxamers (sometimes referred to under the trade names Pluronic, Synperonics, and Kolliphor). In general, the total amount of carrier in the major solid phase (which is the sum of all of the components comprising the carrier) will be at or above 90% by weight of the major solid phase, or at or above 95% by weight of the major solid phase, or in the range of between 90% by weight and 99% by weight of the major solid phase, or in the range of between 90% by weight and 97.5% by weight of the major solid phase, or in the range of between 90% by weight and 95% by weight of the major solid phase, or in the range of between 95% by weight and 99% by weight of the major solid phase, or in the range of between 95% by weight and 97.5% by weight of the major solid phase, or in the range of between 97.5% by weight and 99% by weight of the major solid phase.

The carrier may also comprise the hydrated salts. Examples of hydrated salts include, but are not limited to, sodium acetate trihydrate, magnesium nitrate hexahydrate, magnesium chloride hexahydrate, and magnesium sulfate heptahydrate (also known as Epsom salt). In general, the hydrated salt should have a melting point of less than 150° C., preferably less than 125° C., most preferably less than 100° C. Especially preferred hydrated salts will have a melting point below 60° C. The amount of hydrated salt may be at or above 20% by weight of the major solid phase, at or above 30% by weight of the major solid phase, at or above 40% by weight of the major solid phase, or in the range of between 20% by weight and 40% by weight of the major solid phase, or in the range of between 20% by weight and 35% by weight of the major solid phase, or in the range of between 20% by weight and 30% by weight of the major solid phase, or in the range of between 25% by weight and 40% by weight of the major solid phase, or in the range of between 25% by weight and 35% by weight of the major solid phase, or in the range of between 30% by weight and 40% by weight of the major solid phase.

The fragrance may be at or above 2% by weight of the major solid phase, at or above 6% by weight of the major solid phase, at or above 10% by weight of the major solid phase, or in the range of between 2% by weight and 10% by weight of the major solid phase, or in the range of between 2% by weight and 8% by weight of the major solid phase, or in the range of between 2% by weight and 6% by weight of the major solid phase, or in the range of between 4% by weight and 10% by weight of the major solid phase, or in the range of between 4% by weight and 8% by weight of the major solid phase, or in the range of between 6% by weight and 10% by weight of the major solid phase.

The fragrance may be—or may comprise—a fragrance oil. Fragrance oils are available from multiple sources, such as Berjd, Cateret, N.J.; Firmenich, Geneva, Switzerland; Givaudan, Vernier, Switzerland; International Flavors & Fragrances, New York, N.Y.; and Symrise, Holzminden, Germany. When used, the amount of fragrance oil may be at or above 1% by weight of the major solid phase, at or above 3% by weight of the major solid phase, at or above 5% by weight of the major solid phase, or in the range of between 1% by weight and 10% by weight of the major solid phase, or in the range of between 1% by weight and 7.5% by weight of the major solid phase, or in the range of between 1% by weight and 5% by weight of the major solid phase, or in the range of between 2.5% by weight and 10% by weight of the major solid phase, or in the range of between 2.5% by weight and 7.5% by weight of the major solid phase, or in the range of between 5% by weight and 10% by weight of the major solid phase.

The fragrance may be—or may comprise—a perfume microencapsulate or microcapsule. By the term perfume microencapsulate or microcapsule it is meant those microcapsules described in United States Patent Publication No. 2013/0267454 A1, the teachings of which are incorporated by reference herein in their entirety. When used, the amount of perfume microencapsulate or microcapsule may be at or above 1% by weight of the major solid phase, at or above 3% by weight of the major solid phase, at or above 5% by weight of the major solid phase, or in the range of between 1% by weight and 10% by weight of the major solid phase, or in the range of between 1% by weight and 7.5% by weight of the major solid phase, or in the range of between 1% by weight and 5% by weight of the major solid phase, or in the range of between 2.5% by weight and 10% by weight of the major solid phase, or in the range of between 2.5% by weight and 7.5% by weight of the major solid phase, or in the range of between 5% by weight and 10% by weight of the major solid phase. The perfume microencapsulate or microcapsule may be utilized in addition to or instead of the fragrance oil.

In all embodiments, all the weight percent of all the components of the major solid phase combine to total 100% by weight of the major solid phase.

The minor solid phase(s) may comprise a variety of compositions whose presence add or increase certain performance characteristics of the laundry pastille. One example of such a composition is a fragrancing composition. Another example of such a composition is a cleaning composition. Yet another example of such a composition is a disinfecting composition, which may also be referred to as a sanitizing composition. Still another example of such a composition is an optical brightener. The fragrancing composition, cleaning composition, disinfecting composition, and optical brightener may exist alone or in various combinations in the minor solid phase(s). In some embodiments, there may be a plurality of minor solid phases, each of which comprises a different composition. That is to say, that the first minor solid phase may comprise a composition selected from the group consisting of at least one fragrancing composition, at least one cleaning composition, at least one disinfecting composition, at least one optical brightener, and combinations thereof. Each subsequent minor solid phase may also comprise a composition selected from the group consisting of at least one fragrancing composition, at least one cleaning composition, at least one disinfecting composition, at least one optical brightener, and combinations thereof.

In some embodiments, the minor solid phase(s) may also comprise a carrier. The carrier may comprise an amount of polyethylene glycol and an amount of a hydrated salt. The polyethylene glycol may be of any type and present in any amount disclosed herein with reference to the major solid phase. Alternatives which may be used in addition to or in place of polyethylene glycol may include sodium acetate, polyethylene glycol monostearyl ether (sometimes referred to as Steareth), the polyethylene glycol stearates, and the poloxamers (sometimes referred to under the trade names Pluronic, Synperonics, and Kolliphor). The hydrated salt may be of any type and present in any amount disclosed herein with reference to the major solid phase.

When present, the fragrancing composition may be selected from the group consisting of at least one odor eliminator, at least one fragrance oil, at least one micro-encapsulated fragrance in solid form, and combinations thereof. Non-limiting examples of an odor eliminator include zinc ricinoleate, beta-cyclodextrin, zinc polyitaconate, and combinations thereof. The fragrance oil—when present in the fragrancing composition—may include any of the fragrance oils disclosed herein. The micro-encapsulated fragrance in solid form—when present—may include any of the perfume microencapsulates or microcapsules disclosed herein.

When present, the cleaning composition may be selected from the group consisting of at least one enzyme, at least one surfactant, and combinations thereof. Non-limiting examples of an enzyme include at least one protease enzyme, at least one amylase enzyme, at least one lipase enzyme, at least one cellulase enzyme, at least one mannanse enzyme, and combinations thereof. Non-limiting examples of a surfactant include anionic surfactants, nonionic surfactants, and combinations thereof. Non-limiting examples of anionic surfactants include sodium alkylbenzene sulfonate, sodium olefin sulfonate, sodium alkyl sulfate, and combinations thereof. Non-limiting examples of nonionic surfactants include polyethoxylated alcohols, polypropoxylated alcohols, polyalkoxylated alcohols, polyethoxylated amines, polypropoxylated amines, polyalkoxylated amines, and combinations thereof.

Non-limiting examples of a disinfecting composition (also known as a sanitizing composition) include halogen bleaches, quaternary ammonium compounds, phenolics, o-Phenoxyphenol, chlorophenols such as tricolosan and 2,4,4′-trichloro-2′-hydroxydiphenyl ether, pine oil, formaldehyde generators, acids such as glycolic acid, sorbic acid, and benzoic acid; sodium hydroxymethyl glycinate, boric acid, and combinations thereof.

Non-limiting examples of an optical brightener include diaminostilbene (DAS) type optical brighteners, Distyrylbiphenyl (DSBP) type optical brighteners, polysulfonated triazolyl type optical brighteners, and combinations thereof.

The major solid phase and minor solid phase(s) of the laundry pastille (100) may take many forms as shown in the Figures. In one form—shown in FIG. 2 through FIG. 7—the minor solid phase(s) (120) may be configured as a plurality of specks distributed in the major solid phase (110).

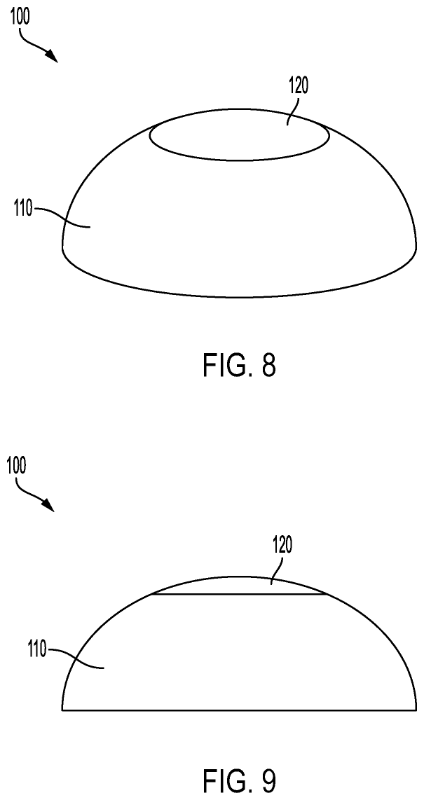

In another form—shown in FIG. 8 through FIG. 13—the minor solid phase(s) (120) may be configured as a dot in the major solid phase (110). While the dot shown in FIG. 8 through FIG. 13 has a circular shape, many other shapes are contemplated including a square shape, a rectangular shape, a heptagonal shape, a hexagonal shape, an octagonal shape, an ovular shape, and a trapezoidal shape.

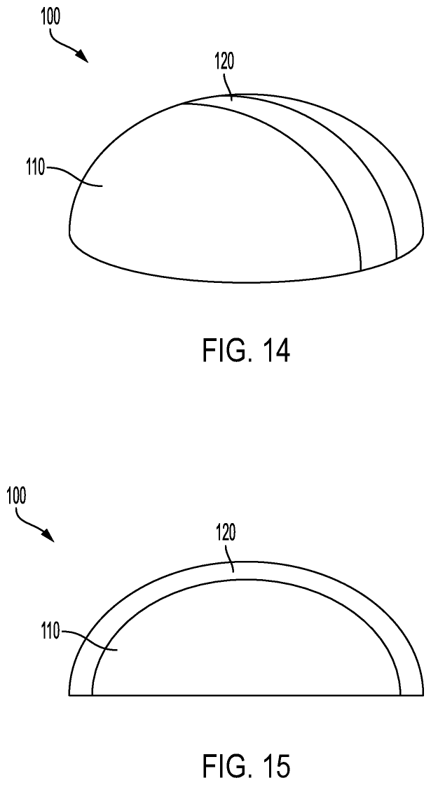

In another form—shown in FIG. 14 through FIG. 19—the minor solid phase(s) (120) may be configured as a stripe in the major solid phase (110).

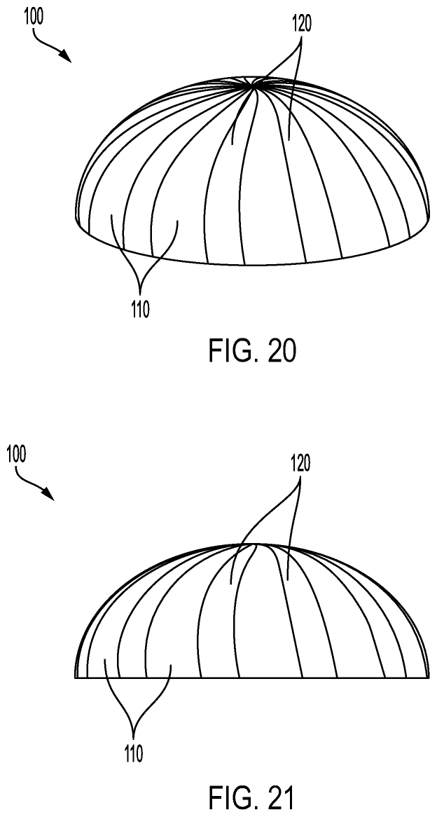

In another form—shown in FIG. 20 through FIG. 25—the minor solid phase(s) (120) may be configured as a swirl in the major solid phase (110).

While the pastilles described herein have been described as a laundry pastille, and in particular a laundry scent booster, other applications may exist. For example, the pastilles may be used as a laundry detergent, a dishwasher detergent, a concentrated cleaning solution to be added to water or another solvent, a surface deoder composition, or a composition for cleaning or sanitizing a garbage disposal. Such pastilles will generally include a carrier of any type and in any quantity described herein. Such pastilles may also include one or more of a fragrance, a fragrancing composition, an enzyme, a surfactant, a disinfecting composition, an optical brightener, and combinations thereof as described herein.

By including the second (and optionally subsequent) plurality of laundry pastilles in the container, the total plurality of laundry pastilles may provide multiple benefits to the total laundry scent booster including fragrancing, cleaning, stain removal, deodorizing, and sanitizing. Similarly, by including the minor solid phase(s) in an individual laundry pastille, the laundry pastilles may provide multiple benefits to the laundry scent booster including fragrancing, cleaning, stain removal, deodorizing, and sanitizing.

1. A container (10) comprising a total plurality of laundry pastilles comprising:
a first plurality of laundry pastilles (20) of the total plurality of laundry pastilles; and
a second plurality of laundry pastilles (30) of the total plurality of laundry pastilles; and
wherein each laundry pastille of the first plurality of laundry pastilles comprises a laundry scent booster composition,
each laundry pastille of the second plurality of laundry pastilles comprises a composition which increases a performance characteristic of the total plurality of laundry pastilles,
the first plurality of laundry pastilles comprises between 50% by weight and 99% by weight of the total plurality of laundry pastilles,
the second plurality of laundry pastilles comprises between 1% by weight and 50% by weight of the total plurality of laundry pastilles, and
the weight percent of the first plurality of laundry pastilles and the second plurality of laundry pastilles combine to total 100% by weight of the total plurality of laundry pastilles.

2. The container of claim 1, wherein the laundry scent booster composition comprises:
a carrier; and
a fragrance; and
wherein the carrier is present in the laundry scent booster composition in a first amount in the range of between 90% by weight and 99% by weight of the laundry scent booster composition, the fragrance is present in the laundry scent booster composition in a second amount in the range of between 2% by weight and 10% by weight of the laundry scent booster composition, and the weight percent of all the components of the laundry scent booster composition combine to total 100% by weight of the laundry scent booster composition.

3. The container of claim 2, wherein the carrier comprises at least one component selected from the group consisting of polyethylene glycol, sodium acetate, polyethylene glycol monostearyl ether, the polyethylene glycol stearates, and the poloxamers.

4. The container of claim 2, wherein the carrier comprises polyethylene glycol having a number-averaged molecular weight from about 2000 to about 4000.

5. The container of claim 2, wherein the carrier comprises a hydrated salt selected from the group consisting of sodium acetate trihydrate, magnesium nitrate hexahydrate, magnesium chloride hexahydrate, and magnesium sulfate heptahydrate, and wherein the hydrated salt has a melting point of less than 150° C.

6. (canceled)

7. The container of claim 2, wherein the fragrance comprises a fragrance oil.

8. (canceled)

9. The container of claim 1, wherein the fragrance comprises a perfume microencapsulate or microcapsule.

10. (canceled)

11. The container of claim 1, wherein the composition which increases a performance characteristic of the total plurality of laundry pastilles comprises a composition selected from the group consisting of a fragrancing composition, a cleaning composition, at least one disinfecting composition, and at least one optical brightener, wherein the fragrancing composition when present is selected from the group consisting of at least one odor eliminator, at least one fragrance oil, and at least one micro-encapsulated fragrance in solid form, and wherein the cleaning composition when present is selected from the group consisting of at least one enzyme and at least one surfactant.

12. (canceled)

13. (canceled)

14. (canceled)

15. The container of claim 1, wherein the first plurality of laundry pastilles has a different color than the second plurality of laundry pastilles.

16. (canceled)

17. (canceled)

18. (canceled)

19. (canceled)

20. A laundry pastille comprising:
a major solid phase comprising a carrier and a fragrance; and
at least one minor solid phase; and
wherein the carrier is present in the major solid phase in a first amount in the range of between 90% by weight and 99% by weight of the major solid phase, the fragrance is present in the major solid phase in a second amount in the range of between 2% by weight and 10% by weight of the major solid phase, and the weight percent of all the components of the major solid phase combine to total 100% by weight of the major solid phase.

21. (canceled)

22. The laundry pastille of claim 20, wherein the carrier comprises at least one component selected from the group consisting of polyethylene glycol, sodium acetate, polyethylene glycol monostearyl ether, the polyethylene glycol stearates, and the poloxamers.

23. (canceled)

24. The laundry pastille of claim 20, wherein the carrier comprises a hydrated salt selected from the group consisting of sodium acetate trihydrate, magnesium nitrate hexahydrate, magnesium chloride hexahydrate, and magnesium sulfate heptahydrate, and the hydrated salt has a melting point of less than 150° C.

25. (canceled)

26. The laundry pastille of claim 20, wherein the fragrance comprises a fragrance oil.

27. (canceled)

28. The laundry pastille of claim 20, wherein the fragrance comprises a perfume microencapsulate or microcapsule.

29. (canceled)

30. The laundry pastille of claim 20, wherein at least one of the at least one minor solid phase comprises a composition selected from the group consisting of a fragrancing composition, a cleaning composition, at least one disinfecting composition, and at least one optical brightener, and wherein the fragrancing composition when present is selected from the group consisting of at least one odor eliminator, at least one fragrance oil, and at least one micro-encapsulated fragrance in solid form, and wherein the cleaning composition when present is selected from the group consisting of at least one enzyme and at least one surfactant.

31. (canceled)

32. (canceled)

33. (canceled)

34. The laundry pastille of claim 20, wherein the at least one minor solid phase is present in the major solid phase as a plurality of specks distributed in the major solid phase.

35. The laundry pastille of claim 20, wherein the at least one minor solid phase is present in the major solid phase as a dot in the major solid phase.

36. The laundry pastille of claim 20, wherein the at least one minor solid phase is present in the major solid phase as a stripe in the major solid phase.

37. The laundry pastille of claim 20, wherein the at least one minor solid phase is present in the major solid phase as a swirl in the major solid phase.

38. The laundry pastille of claim 20, wherein the major solid phase and the minor solid phase each have a different color.

39. (canceled)
